(19) United States
(12) Patent Application Publication
(10) Pub. No.: US 2017/0076016 A1
(43) Pub. Date: Mar. 16, 2017

(54) AUTOMATED LAYOUT GENERATION

(71) Applicants: Maysam MIR AHMADI, Coquitlam (CA); Abdallah SHAMI, London (CA); Brad DE VLUGT, Kitchener (CA); Peyman YADEMELLAT, North York (CA)

(72) Inventors: Maysam MIR AHMADI, Coquitlam (CA); Abdallah SHAMI, London (CA); Brad DE VLUGT, Kitchener (CA); Peyman YADEMELLAT, North York (CA)

(21) Appl. No.: 15/261,742

(22) Filed: Sep. 9, 2016

Related U.S. Application Data
(60) Provisional application No. 62/216,629, filed on Sep. 10, 2015.

(51) Int. Cl. G06F 17/50

(52) U.S. Cl. CPC G06F 17/5004; G06F 2217/08

(57) ABSTRACT

Systems and methods for use in the generation of layouts for spaces. User defined parameters are entered and, based on the user inputs and the system configuration, a layout for the space is provided. First, the space is defined in terms of dimensions and shape. Second, the desired areas or rooms are generated including areas for specific rooms as may be defined by user input. These rooms are then placed within the space. Constraints provided by the user input and system configuration are complied with when placing the rooms in the space. Third, corridors are determined to ensure that connectivity between rooms exist. Finally, the corridors are placed and the sizes of the various rooms are adjusted to account for the space used by the corridors.

### RELATED APPLICATIONS

This application is a non-provisional patent application which claims the benefit of U.S. Provisional Application No. 62/216,629 filed on Sep. 10, 2015.

### TECHNICAL FIELD

The present invention relates to software for use with architecture and architectural design. More specifically, the present invention relates to methods and systems for use in the automatic generation of designs and layouts for spaces including houses and offices.

### BACKGROUND

The rise of computer gaming in recent years has led to a call for better and less tedious methods for generating virtual spaces which may be used for such games. Dynamic generation of virtual environments has gained popularity in response to this call. Generating dynamic virtual environments for each round of the game allows even savvy gamers to enjoy the game. For quite a lot of computer games, especially those which use higher end graphics, a lot of the scenes take place in towns, cities, or urban and semi-urban environments. These environments have to be generated either manually or with a rule-based procedure. In some massive multiplayer games, producing a whole world may be required, necessitating the generation (and population with suitable furniture and decorations) of hundreds if not thousands of houses, castles, offices, shopping malls, and other indoor environments.

As can be imagined, aside from the scale of the virtual environment, the details for such environments are important. Creating environments which enable the player to enter and explore buildings adds a layer of design which multiplies the complexity of the task. Because of this, creating and managing such indoor environments can constitute a large portion of game level design. There are, of course, other uses for the creation of indoor environments. A model describing the interior of buildings can also be used in, for example, to statistically model the signal propagation in built-up areas or used as a hypothetical signal propagation benchmark which can be customized to adapt to different scenarios.

There is therefore a need for systems and methods which can be used to generate layouts for spaces with desired areas. Preferably, the generation of the layouts is automatic and can be based on user provided input as well as on building codes.

### SUMMARY

The present invention provides systems and methods for use in the generation of layouts for spaces. User defined parameters are entered and, based on the user inputs and the system configuration, a layout for the space is provided. First, the space is defined in terms of dimensions and shape. Second, the desired areas or rooms are generated including areas for specific rooms as may be defined by user input. These rooms are then placed within the space. Constraints provided by the user input and system configuration are complied with when placing the rooms in the space. Third, corridors are determined to ensure that connectivity between rooms exist. Finally, the corridors are placed and the sizes of the various rooms are adjusted to account for the space used by the corridors.

In a first aspect, the present invention provides a method for generating at least one design layout for a space, the method comprising:
a) receiving parameters for said space;
b) determining a number and type of desired areas for said space;
c) determining dimensions of said desired areas;
d) placing said desired areas in said space based on predetermined constraints;
e) determining connecting corridors for said space to connect at least one desired area with another desired area;
f) adjusting dimensions of said desired areas to account for said connecting corridors; and
g) placing said connecting corridors in said space.

In a second aspect, the present invention provides non-transitory computer readable media having encoded thereon computer readable and computer executable code which, when executed, implements a method for generating at least one design layout for a space, the method comprising:
a) receiving parameters for said space;
b) determining a number and type of desired areas for said space;
c) determining dimensions of said desired areas;
d) placing said desired areas in said space based on predetermined constraints;
e) determining connecting corridors for said space to connect at least one desired area with another desired area;
f) adjusting dimensions of said desired areas to account for said connecting corridors; and
g) placing said connecting corridors in said space.

In a third aspect, the present invention provides a method for generating at least one design layout for a space, the method comprising:
a) receiving a number and type of desired areas for said space;
b) determining desired dimensions and other parameters for said space;
c) determining a connectivity of rooms within said space;
d) receiving instructions to generate layouts for said space;
e) receiving parameters for use in determining a suitability of a layout;
f) generating multiple layouts for said space based on said instructions;
g) searching said multiple layouts for layouts suitable for said space based on said parameters received in step e)
h) optimizing layouts determined to be suitable in step g) based on said instructions;
i) adjusting layouts optimized in step h) based on instructions received in step d).

### BRIEF DESCRIPTION OF THE DRAWINGS

The embodiments of the present invention will now be described by reference to the following figures, in which identical reference numerals in different figures indicate identical elements and in which:

FIG. 1 is a block diagram detailing the software modules in one aspect of the invention;

FIG. 2 is a sample hierarchy graph for a residential space detailing the rooms in the space;

FIG. 3 illustrates a tree graph and its corresponding space division;

FIG. 4 illustrates two steps in a room placement;

FIG. 5A illustrates a layout in need of a corridor;

FIG. 5B shows the connectivity graph for the layout in FIG. 5A;

FIG. 5C illustrates the final corridor placement based on the connectivity graph in FIG. 5B;

FIGS. 6A-6C illustrate the various options when placing and configuring a corridor;

FIG. 7 shows a final floor plan with the corridor placed along with the various rooms;

FIG. 8 shows a sample user generated requirements document for a projected office space;

FIG. 8A is a connectivity diagram showing the desired connectivity between various rooms in a layout and which may form part of a user generated requirements document;

FIG. 9 is a sample output layout generated by a Squarified Treemap method;

FIG. 10 illustrates the minimal partition of a rectilinear shape;

FIG. 11 illustrates an example of an adjustment or fine tuning of a layout; and

FIG. 12 is a block diagram illustrating the various components in a sample implementation of one aspect of the present invention.

### DETAILED DESCRIPTION

The present invention is designed to produce layouts or room and corridor placements for specific spaces.

It should be noted that the present invention may be used to generate layouts for single floor houses, floor layouts for hotels, layouts for offices, and any other layouts for generally flat, two-dimensional spaces. For ease of understanding, the term “room” and “desired area” are to be taken as synonymous in this document. These terms encompass the concept of an area with a desired and specific function and may include, among others, bedrooms, living rooms, offices, hotel rooms, bathrooms, closets, dens, conference rooms, kitchens, pantries, storage rooms, reception areas, foyers, dining rooms, breakfast nooks, terrariums, and balconies.

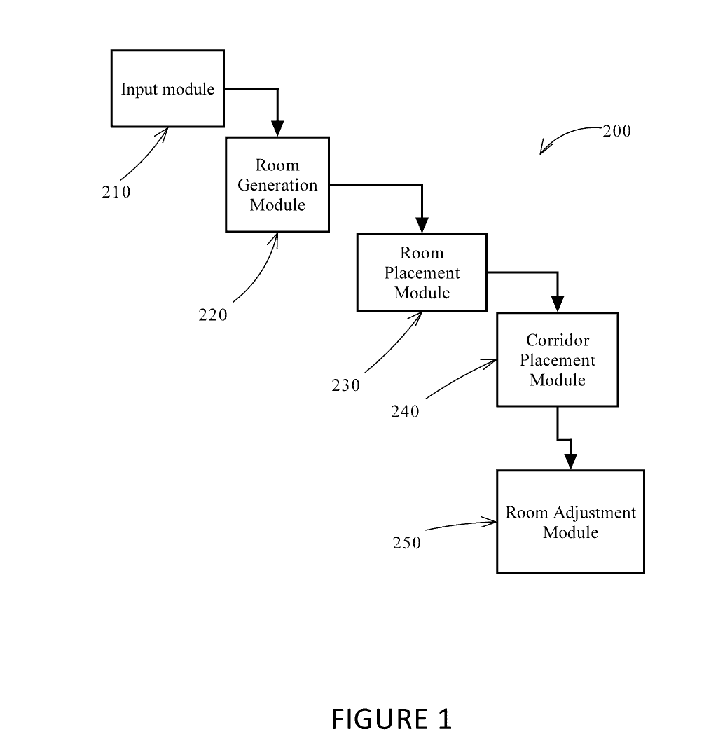

The system according to the invention may be implemented using the modules illustrated in FIG. 1. As can be seen, the system 200 includes an input module 210, a room generation module 220, a room placement module 230, a corridor placement module 240, and a room adjustment module 250.

The input module 210 receives the parameters for the space for which a layout is desired. The input module may receive the necessary parameters for the space by way of an input file or by way of direct input from a user. Direct input from a user may be by way of a detailed questionnaire, a form, or any well-known methods for gathering desired parameters. The parameters may include the dimensions of the space (e.g. the length and width of the space), the number of rooms, the type of rooms, desired dimensions for at least one room, which rooms are to be nested (i.e. which rooms are within other rooms), which rooms should have windows, and which rooms need to be directly connected to other rooms. In the event there is minimal user input, the parameters can be randomly generated based on statistical models as will be explained below. The resulting parameters can then be used by the system.

The parameters received by the input module 210 are passed to the room generation module 220. The room generation module generates the rooms which are to be placed within the space based on the received parameters as well as the configuration of the system. If the received parameters or the system configuration indicate that specific rooms or spaces are to be nested, then the nested rooms are generated for placement by the next module. As well, if the received parameters indicate that a specific room has to have specific dimensions, the room with the desired dimensions are generated and are rendered ready for placement in the next module. Other parameters which may affect the generation of specific rooms may be the requirement that specific rooms have windows, that specific rooms need to be at a specific area of the space (e.g. a specific office with specific dimensions have to be at a corner of the space or a living room has to be as close to the center of the house as possible). It should be noted that, in the event there are no parameters entered for any specific room, the room area may be randomly generated or may be generated based on the projected function of the room. As an example, a living room may be configured to have the largest area of all the rooms in the house with the main bedroom as having the second largest area in the house. For this eventuality when no dimension parameters are entered for specific rooms, the room sizes may be generated by the next module.

Once the rooms have been generated, these rooms or desired spaces are then placed within the space by the room placement module 230. The order in which the rooms are placed in the space may be dictated by the requirements as detailed in the received parameters. As an example, if a specific room has to be placed at a specific corner of the space, this room is placed first. If, on the other hand, no rooms are configured with specific dimensions, the room placement may be accomplished based on the room function and statistical results of known similar spaces.

With the rooms placed in the space, corridors may be required to connect specific rooms. Depending on the requirements received or the configuration of the system, specific rooms may need to have access to other rooms. As an example, for a residential layout, all the main rooms should have access to the bathroom without the need to pass through another room. Similarly, for an office layout, a bathroom should be easily accessible to the offices as well as to the reception area. The corridor placement module 240 receives the layout generated by the room placement module 230 and determines where corridors are required.

Once the locations of the corridors are determined, these corridors need to be placed. To place the corridors, space has to be allocated for each corridor with a corresponding adjustment to the size of the rooms affected. The adjustment of the room sizes are executed by the room adjustment module 250 and these adjustments are executed with reference to any desired parameters as entered by way of the input module. As an example, if a specific room's area is to be reduced due to the placement of a corridor and this room has required dimensions, the area for the corridor will need to be taken, if possible, from adjoining rooms. The room adjustment module 250 receives the layout from the corridor placement module 240 and adjusts the room sizes as necessary to account for the required corridors. The resulting layout can then be the output of the system.

It should be noted that the system, in one implementation, assumes that the space is square or square-like or similar to a rectangle in shape. Of course, in other implementations, such an assumption need not be made as the invention is also useful for non-rectangular or non-rectilinear spaces. A rectangular space is easier to implement and the placement of the rooms is simplified. As well, the rooms are assumed to be rectangular in shape. Also, to simplify the implementation, a number of other assumptions were made about the space. The first is that no two rooms or areas within the space can overlap. Similarly, no room within the space can protrude the boundary of the space. Another assumption is that all significant areas within the space are to be used. For at least one implementation, in instances where no dimensions were provided for specific rooms or areas, the area of such rooms is implemented as a random variable whose statistical properties are based on its function. Finally, the assumption is made that the floor plan or layout should be connected. i.e., there is at least one way to go from one room to the other. In other words, the connectivity graph is a connected graph.

In addition to the above assumptions, some preferences were also implemented. These include the idea that generating narrow long rooms which would be perceived as unnatural and should therefore be avoided as much as possible. Similarly, the system as implemented assumes a number of windows for residential spaces and, for all spaces, it is assumed that there is at least one door connecting the space to the outside.

The shape of the space may be determined based on the user input parameters. In the event there is no user input, the function of the space may be used as a baseline to determine the shape of the space. For residential spaces, in one implementation, the shape of space is modeled by its aspect ratio, defined as,

AR=max(b/h,h/b)

where AR, b, and h are the aspect ratio, base and height of the rectangle representing the space, respectively. An area with a narrow shape, such as a rectangle with large aspect ratio, is simply regarded as unsuitable for residential spaces in real life and is not considered in this implementation of the invention. Again for residential spaces, the area and aspect ratio of the space are random variables with predetermined distribution. For a given neighbourhood, the statistical properties of these random variables can be sampled from aerial photos.

Once the shape and size of the space has been determined, either through random generation (based on statistical studies) or through user input, the rooms or areas to be placed within the space are then determined.

To generate the rooms or areas to be placed within the space, user input can be used or, for residential spaces, statistical analyses may be used. In one implementation for residential spaces, the random variables, such as the number of rooms and types of rooms to be placed within the space, are generated based on the joint probability distribution of the number of bedrooms and the number of rooms which is extracted from a 2001 census of Canada and shown in Table I.

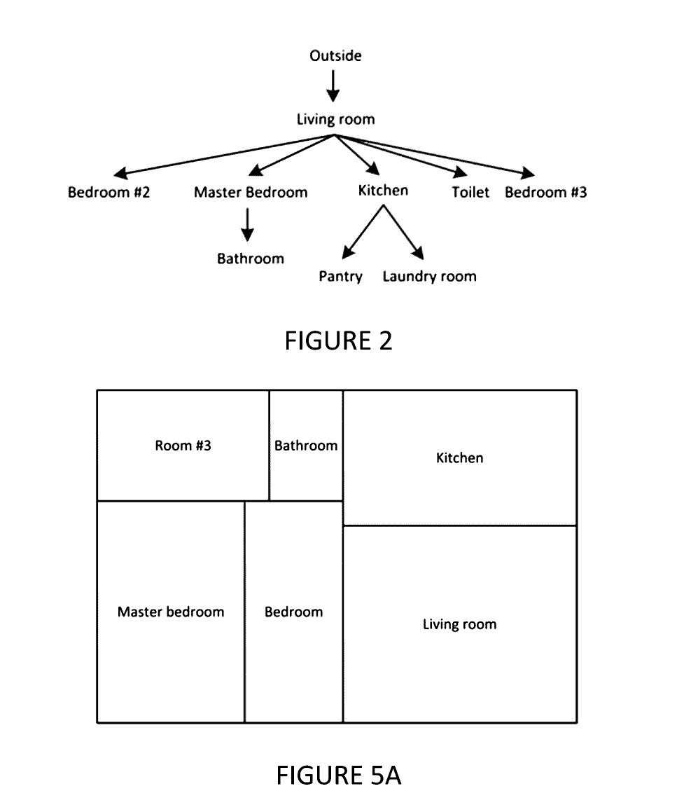

For this implementation, the area of each room is a random variable whose distribution depends on the room's function. As an example, the living room is typically the largest room in a house, while the storage rooms are the smallest ones. The rooms of a house can be divided into three categories based on their functionality: service areas including kitchen and laundry room, private areas composed of bedrooms and bathrooms, and social areas such as the living room and the dining room. After generating the area of each room, the area of each part of the house, i.e., social, service, and private part, is calculated. The rooms are then put into a hierarchical tree graph based on their functionality and the functionality of other rooms. The hierarchy starts the outside of the space and this outside is normally directly connected to the living room as the center of the daily life. The other rooms are included as branches below it. FIG. 2 is provided as a sample hierarchy graph for a residential space. The system uses a collective distribution for all types of the rooms to determine if a house is equipped with a specific room. Census data can be used to find some distribution parameters.

To associate functions to the generated rooms, the system may use a list called the priority list. The system sorts the rooms in order of their importance. The area of each room is then specified or determined based on the selected function of the room. The functionality or function of the room determines its distribution and thus, the size of the room. To customize the output and match it to a different type of building, the priority list and area distributions can be adjusted.

Once the size of each room has been determined, the various rooms are then to be placed inside the space.

For this stage, the system uses a rule-based method to place the rooms in the hierarchy tree based on the room's function. The actual placement or positioning of each room is dependent on where each room is in the hierarchy tree. As an example, the kitchen is connected to the living room either directly or via the dining room and hence, it is placed under the living room directly or via the dining room. In some cases, the position of a room in the hierarchy tree also depends on the function of other rooms. For example, in a typical residential space, there should be a bathroom connected to the common area. Extra bathrooms are typically inside a master bedroom or other large bedrooms. Therefore, there needs to be a bathroom connected directly to the common area and there may be several other bathrooms connected to bedrooms. For this rule-based method, a number of basic rules are used to create the hierarchy tree:
1) Place outside node as the root.
2) Place living room below outside.
3) If there is a kitchen, place it below living room.
4) If there is any bedroom, place the largest one under living room and name it Master bedroom.
5) If there is just one bathroom, place it below living room.
6) Place the remaining bathroom below bedrooms, starting from the largest bedroom.
7) place laundry and pantry below kitchen, if any.

As noted above, the hierarchical tree or graph of rooms for a sample residential space is shown in FIG. 2.

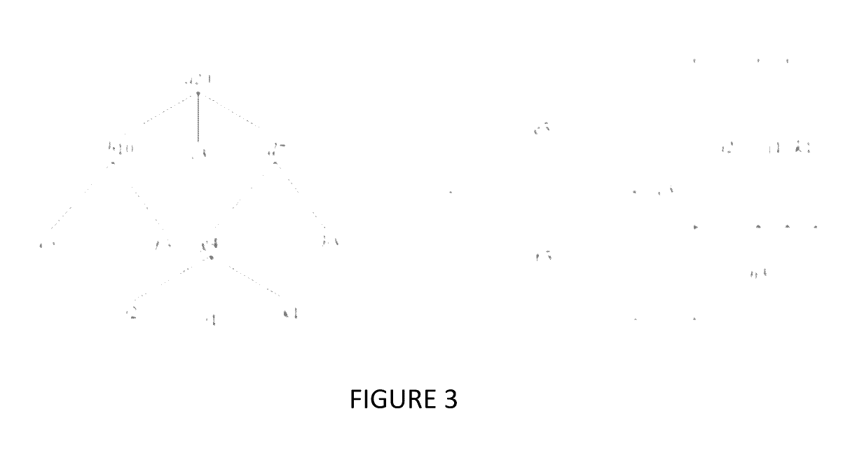

The next step is placing the rooms in the house. For the actual placement, a method called Squarified Treemap {see M. Bruls, K. Huizing, and J. van Wijk, “Squarified treemaps,” in In Proceedings of the Joint Eurographics and IEEE TCVG Symposium on Visualization, 1999, pp. 33-42) places the rooms. The Squarified Treemap method divides a region into several smaller regions with a redefined area without any unused space. It also tries to minimize the aspect ratio of each block to be more square-like in shape. The Squarified treemap method is an extension of the standard Treemap method (see B. Johnson and B. Shneiderman, “Tree-Maps: a space-filling approach to the visualization of hierarchical information structures,” in Proceedings of the 2nd conference on Visualization '91, ser. VIS '91. Los Alamitos, Calif., USA: IEEE Computer Society Press, 1991, pp. 284-291. http://portal.acm.org/citation.cfm?id=949607.949654). This standard method gives priority to the square or square-like shapes. The original Treemap method organizes the spaces in a tree graph such as the one shown in FIG. 3. Also shown in FIG. 3 is the corresponding rectangular division of a space. As can be seen in the figure, the method can generate elongated rectangular subdivisions. Since these subdivisions are not favourable in floor plans or layouts, the Squarified treemap method is adapted for use with the system.

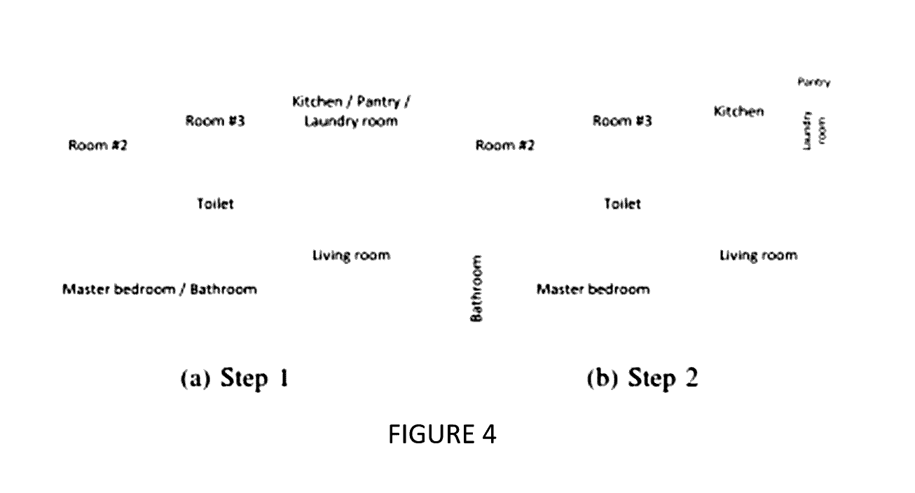

The modified Squarified treemap method first places the rooms from the first level of the hierarchy tree. For this step, the total floor area of nested rooms is determined and the larger room is placed in the space. As an example, if a kitchen includes a pantry and a storage area, the total area to be placed would be the area for the kitchen including the area for the pantry and the storage area. Thus, rooms with the total surface area of all the rooms below it in the hierarchy tree are placed in the space. Once all the rooms in the first level of the hierarchy have been placed, the nested rooms are then placed within their larger rooms. In other words, the system moves to each room and places the relevant smaller rooms within it. Referring to FIG. 4, these two steps are illustrated. In the first step, the main rooms are placed within the space. Then, in the second step, the nested rooms in the kitchen (i.e. the pantry and the laundry room) are placed.

Once the rooms are placed within the space, corridors are then to be placed to connect the various rooms.

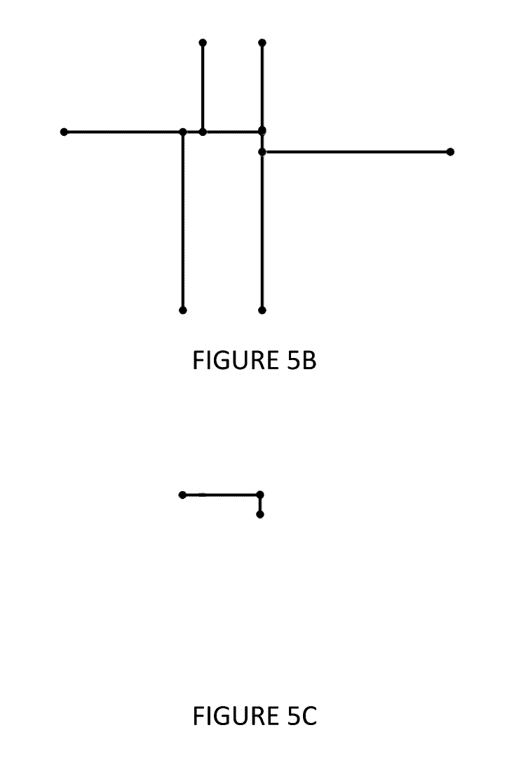

To place the corridors, one must first realize that, in a typical house or residential space, all of the rooms are connected either directly or via some corridors to the living room, typically characterized as the center of activities. The system uses this as the starting point for the corridor layout schemes. The system identifies the rooms that are required to be connected directly to the living room and if they are not adjacent to the living room, the system places a corridor, thereby connecting the rooms to the living room. FIGS. 5A to 5C are provided for ease of reference.

Depending on the number and type of the rooms and their placement, it may be required to place a corridor to connect the rooms together. For example, in FIG. 5A Room #3 cannot be connected to the living room. Thus, a corridor is required to connect the leftmost room (Room #3) to the living room.

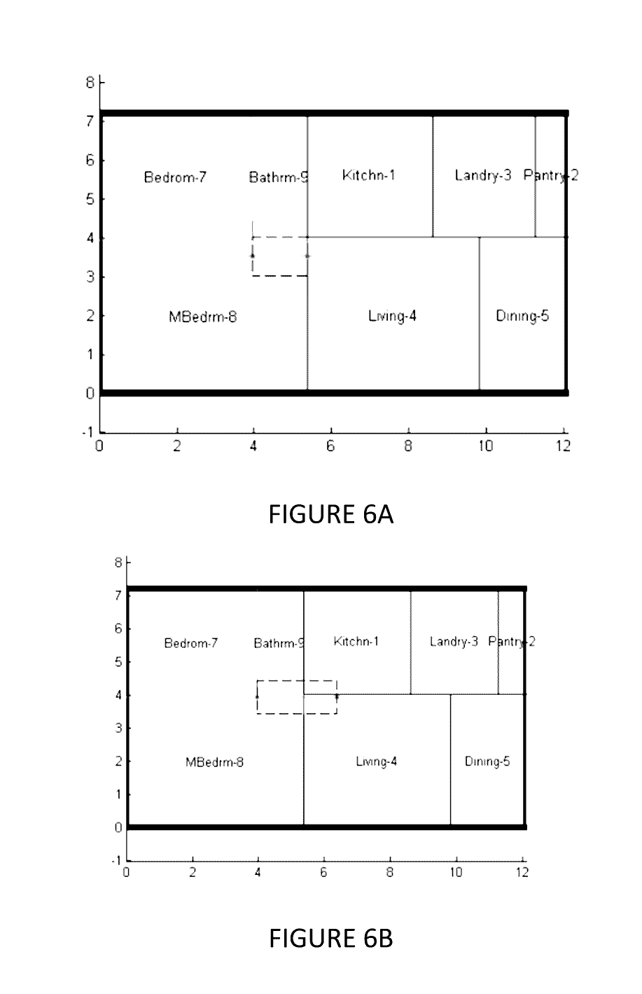

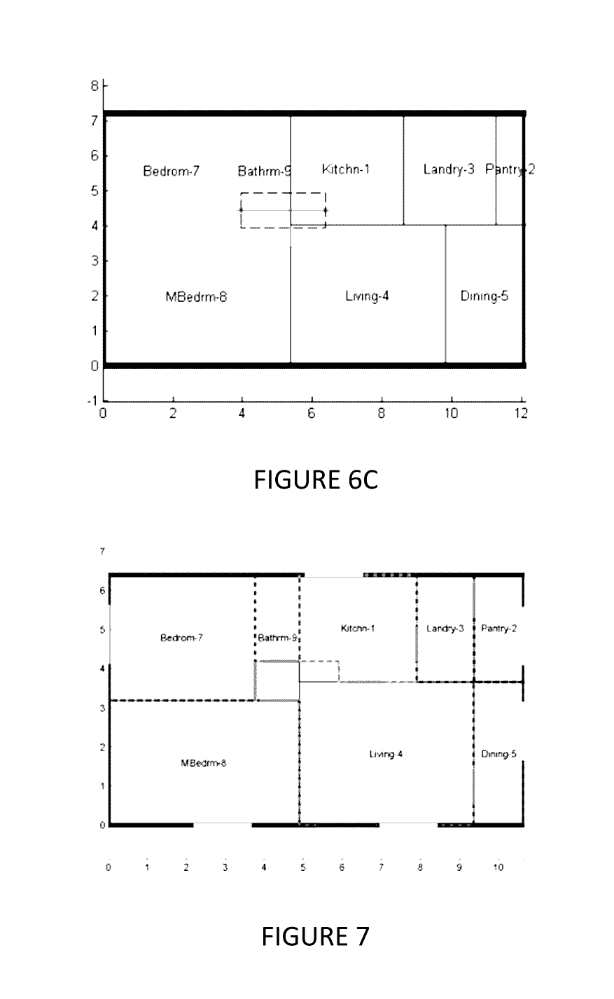

To place corridors, a Corridor Placement method is applied. This method has the following steps:
1) The rooms that require connections are identified. These are referred to as the corridor rooms.
2) A graph is constructed with the walls of the corridor rooms as well as the living room. The outer walls of the space are not considered in this graph. (See FIG. 5B)
3) The graph is the pruned and the edges that connects to a vertex with degree one is removed from the graph. This graph is called a corridor graph. (See FIG. 5C)
4) The shortest path in the graph connecting all the rooms in the graph is chosen using a standard shortest path algorithm (see, for example, E. Dijkstra, “A note on two problems in connexion with graphs,” Numerische mathematik, vol. 1, no. 1, pp. 269-271, 1959). A room is considered connected if it shares an edge or a vertex with the graph. The use of a shortest path algorithm is justified by the fact that corridor area is wasted area in the residential space and has to be minimized. Thus, it is prudent to choose the shortest path which translates to the smallest area wasted.
5) If a room is connected by a vertex and does not have any shared edge, it is required to modify the graph to be able to place a door for the room. This is done by either shifting the edge of the graph to be inside the room or by lengthening the edge connected to the shared vertex. The process is illustrated with reference to FIGS. 6A-6C.

All of the possible choices to modify the corridor graph constitutes the action set:

A={aᵢ,=Shift/Lenghten},∀eᵢεEdges,i=1 . . . Number of edges

Note that selecting proper actions for each edge results in a small corridor. Therefore, an optimization is required to prohibit the generation of bulky corridors and minimize corridor area.
6) The corridor should not change the shape of surrounding rooms in a way that the areas of the rooms become unusable.

Therefore, the corridor graphs that leave peculiar shaped rooms behind are filtered out. Once a suitable set of graphs result, the areas of the corridors resulting from each modified corridor graph are compared. The corridor with the smallest area is then selected. The resulting graph is called the optimized corridor graph.
7) At the last step, the polygon representing the corridor is constructed based on the optimized corridor graph and extruded from the overlapping rooms. The output is the final floor plan. It should be noted that the area of the corridor itself is regarded as the extension of the living room. Therefore, in all subsequent steps, the corridor walls are considered as the living room walls.

It should be clear that the Corridor Placement method is executed by the relevant modules. The corridor placement module determines the various corridor placement options using the steps noted above. The room adjustment module 250 then adjusts the room sizes for each of the corridor placement options. Of these options, the option with the least area is then selected and is then incorporated into the final layout.

It should be clear that the corridor placement can be optimized for best results. As an example, instead of just shifting or lengthening the various walls, a combination of the two may be accomplished. FIGS. 6A-6C illustrate this. FIG. 6A shows the case where the graph edge is shifted downward to align with living room walls. However, this case is not valid as the corridor cannot accommodate a door to the smaller bedroom. FIG. 6B shows the case where a graph edge is lengthened to make room for a door from the corridor to the living room. A combination of upwardly shifting and then lengthening the corridor is shown in FIG. 6C. In the final floor plan shown in FIG. 7, the corridor generated by a combination of upwardly shifting the graph edge (to align with the room boundaries) and lengthening the graph (to make room for a connection to the living room) is selected.

Once corridors have been placed, other fixtures, such as doors and windows, may be placed in the layout. User input regarding doors and connections between rooms may be present, depending on what the user entered using the input module. However, for cases where there is no user input regarding connections between rooms, previous experience or existing designed spaces may be used. Statistical studies have shown that not all of adjacent rooms can be connected together. As an example, bedrooms cannot be connected to the kitchen. To address this issue, the hierarchy tree may be used as the basis for a connection graph which may then augmented by several other edges. For example, it is possible to connect the kitchen and the dining room. It should be clear that the decision to add these optional edges is taken randomly based on the function of both rooms being connected.

Once the connection graph is finalized, the doors are then placed randomly at the shared walls between the rooms to be connected. The door size is fixed and may be adjusted manually by the user. However, their positions in walls are randomly chosen.

For windows, the same approach is taken. The only difference is that the connection graph is constructed regarding the placement of the rooms as well as some restrictive rules. As a general rule, the rooms that share a wall with outside are equipped with a window unless it is prohibited by predetermined rules or by user input received through the input module. As an example of a predetermined rule, a sample rule may be that a window cannot be installed in bathrooms.

The resulting layout for the space is illustrated in FIG. 6. This layout was produced without user entered constraints and the room sizes were generated randomly based on statistics of existing residential spaces. Of course, while the above discussion focuses on residential spaces, the above described system and methods may be used for other spaces such as floor plans for office space.

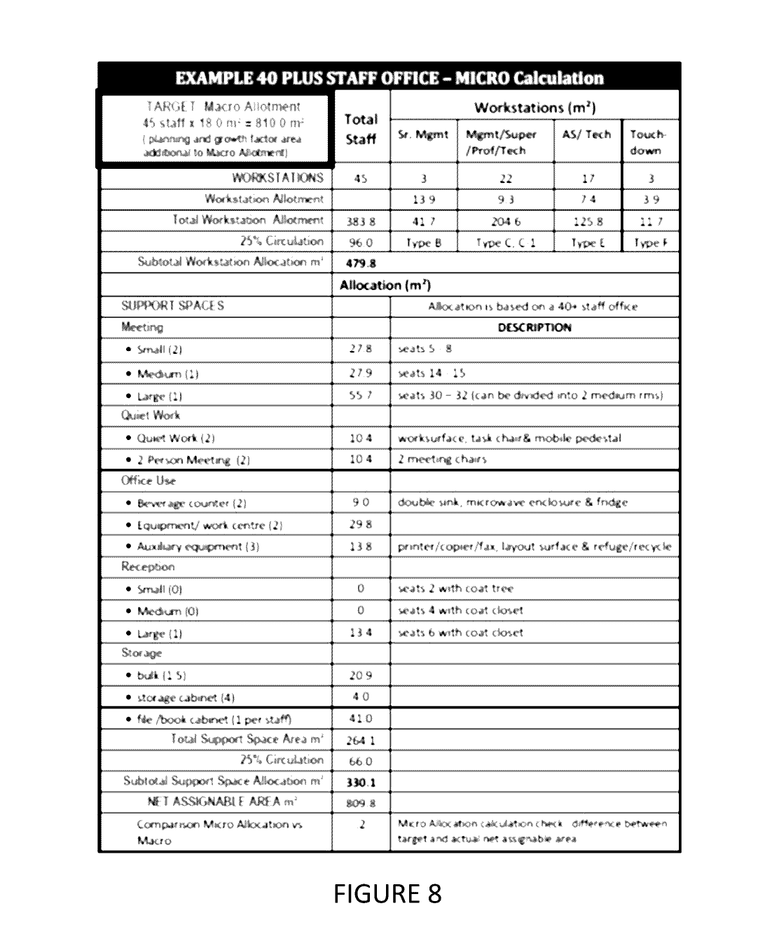

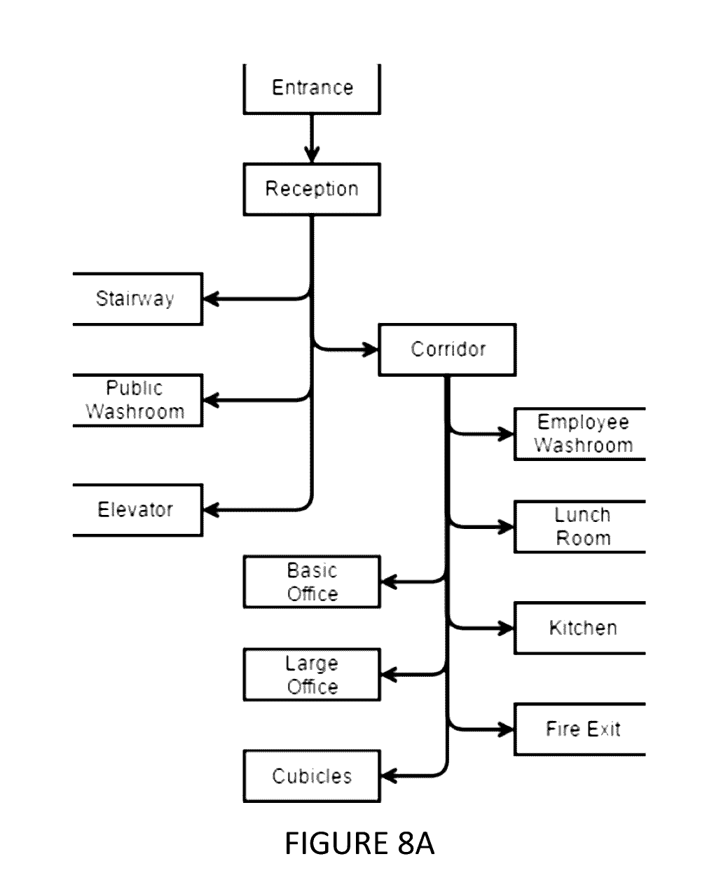

In another implementation of the present invention, the system is provided to automatically generate multiple layouts based on a user provided document detailing requirements for a specific space. An example of such a user provided document is illustrated in FIG. 8. As part of the requirements for a specific space, a user may provide a document such as that illustrated in FIG. 8A. In FIG. 8A, the connectivity between the various rooms in a layout are detailed. To conform to this requirement, a candidate layout would need to have the connectivity between rooms as detailed in the document.

For this implementation, multiple software modules implementing different algorithms for generating layouts are provided in the system. Depending on the user requirements and user input, different modules may be used to generate the layouts.

The above noted modules may include a core methods module containing a library with implementations of multiple core methods for generating layouts. The methods can be classified into three main categories: population generators, optimizers, and fine-tuning methods. Population generators generate multiple layouts generated from the user provided documents and input. These layouts are candidate layouts which form the input to the optimizers. Optimizer methods optimize the layouts it receives and adjust these layouts for a better fit with the user provided documentation and input. Fine tuning methods further adjust the output layouts from the optimizers for an even better fit with the user provided requirements. Once the final layouts are produced, these can be provided to the user.

It should be noted that there are multiple algorithms which may be used to generate candidate layouts. Experiments have been conducted to arrive at methods and algorithms which provide the most useful results. The pseudo-code for a generation method (using a pseudo-backtracking algorithm) which was found to be useful is provided below.

```
1. while layout not generated do
  a. Generate a random array of rooms;
  b. Select the first grid of the layout;
  c. Terminate if the array is empty;
  d. Select the first room in the random array;
  e. while the layout not completed and the last grid
not met do
      i. if the grid is acceptable
        1. Place the room;
        2. Remove the room from the array;
        3. Go to Step 1.c;
      ii. endif
      iii. Move to next grid;
  f. endwhile
2. endwhile
```

A grid is acceptable if the grid is not assigned to any other room and at least one rotation of the selected room can be placed on the layout by considering the selected grid as the coordinates of the room. As can be realized from the pseudo-code, the algorithm terminates when the first feasible solution is found. The random array ensures diversification.

Other than the method outlined above, other population generator methods may also be used. The following optional methods may be used:

Shuffled Squarified Treemap

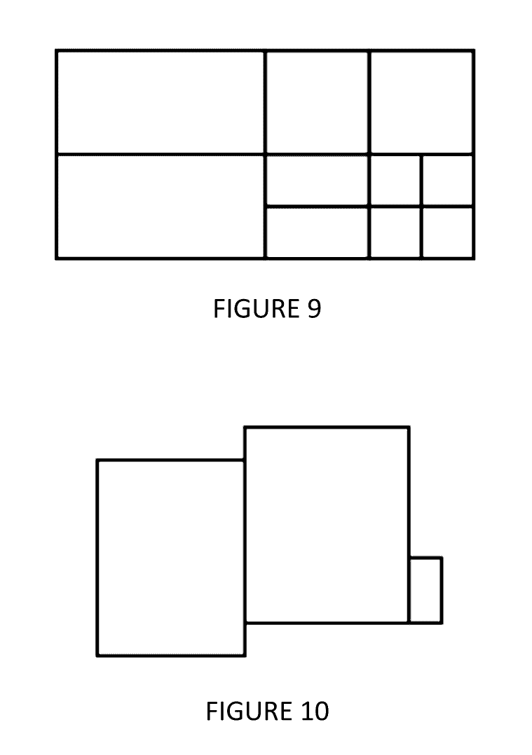

Squarified treemap divides an input rectangle into a set of child rectangles given a list of target areas. The algorithm aims to generate rectangles with aspect ratios close to unity. An example output from the algorithm, given a set of ten Spaces and their target areas, is shown in FIG. 9.

The method for layout population generation, Shuffled squarified treemap, creates a set of N layouts using the squarified treemap algorithm. In order to generate unique layouts, a target area list is shuffled randomly for each treemap. If this area list contains few duplicates, there are O(N!) possible orderings. Thus the probability that the layouts are distinct is large. With shuffling, this generation algorithm is non-deterministic, and thus the set of layouts will be different for each time the algorithm is run.

Minimal Rectilinear Partitioning

Minimal rectilinear partitioning divides a rectilinear shape into a minimum number of rectangles. This algorithm is useful as an extension for the Shuffled Squarified Treemap algorithm to allow generation of populations with a rectilinear rather than rectangular boundary.

An example of a minimally partitioned rectilinear polygon is shown in FIG. 10. To generate a Functional Layout from this partitioned shape, the Spaces can be divided into three sets based on their target areas and the area available in each section. Each set of Spaces is then placed into a treemap with the corresponding partition as the boundary.

Evolutionary Squarified Treemap

Evolutionary algorithms are a class of stochastic optimization algorithms modeled after Darwinian evolution. An iteration of these algorithms begins with a population of candidate solutions, or chromosomes, and performs crossover on them. The crossover operation merges the characteristics from each chromosome in some manner. Subject to a probability, some chromosomes are mutated at the end of an iteration.

The idea of this algorithm is to search through the N! possible orderings of areas passed to the Squarified Treemap algorithm to generate the best possible initial population. The chromosome is defined as the ordering of the Spaces input to the Treemap algorithm. Mutation is defined as randomly swapping the position of two Spaces in the ordering. In one implementation of the algorithm, crossover between two chromosomes is defined as selecting a Space from the chromosome with lower cost and forcing the Space to take that position in the other chromosome. This algorithm is more computationally complex than Shuffled Squarified Treemap alone. However it has the potential to generate an initial population that is more visually appealing. Other variants of the algorithm may also be used.

To arrive at better layouts, filtering may be performed on the candidate layouts produced. A filter is defined as a function that receives a layout as an argument and returns a Boolean denoting a pass or fail. Filtering may be used at any stage during the layout generation stage and filter functions could be both scriptable by a user or be built in components of the system. Filters would enforce constraints on the generated population of layouts through calculations based on the user provided constraints and requirements.

One option for filtering is the N-Best filtering algorithm or method. This maps each layout to a numerical cost using the cost function and then selects the N layouts with the lowest cost as the output. This filtering method reduces a large population of layout candidates to a manageable size for a second, more computationally intensive, optimization stage or to a small sample for visualization purposes. Versions of this method may be used to consider connectivity between spaces as well as to consider other constraints.

Once the candidate layouts have been generated using the generation methods listed above, these layouts may be optimized using optimizer algorithms or methods.

Optimization algorithms or methods begin with a set of candidate solutions and attempt to modify them to increase the number of requirements that are satisfied. The process can be visualized as a search through multi-dimensional space for a global minimum of a multi-objective cost function. Iterations of the optimization visit neighbours of the current solution through mutating the data representation, examining their cost, and selecting a direction to pursue based on a meta-heuristic. Examples of heuristics include simulated annealing (SA), genetic algorithms (GA), and particle swarm optimization (PSO). These examples are discussed in more detail below.

The two classes of mutable data representations used by the optimization algorithms in one implementation of a software library for the system are vector and raster graphics. Vector graphic approaches formulate the spaces as arrays of points and use polygon Boolean operations such as union and intersection to mutate the input data. Raster graphics approaches divide the available area into a grid and formulate spaces as combinations of grid blocks.

One option for optimization is the use of simulated annealing. Simulated annealing is an iterative optimization algorithm or method designed to emulate the behaviour of cooling metal. The algorithm operates on mutable objects that map to a numerical cost and begins with a candidate solution. This solution is copied, mutated, and checked for cost improvement. A mutation that yields positive improvement is accepted as the new starting object and a mutation that yields negative improvement is rejected subject to a probability. The probability of rejection is increased at each stage to induce convergence to a minimum of the cost function.

The simulated annealing algorithm for optimizing a functional layout defines a mutation as shifting a layout's wall. The cost of a layout is calculated based on a weighted sum of parameters such as the number of valid connectivity relationships, the difference between the target areas and the actual areas of each Space and the number of walls in the layout.

Another option for optimizing candidate layouts is particle swarm optimization. A Particle Swarm Optimization (PSO) method is a population-based stochastic optimization technique developed by Eberhart and Kennedy in 1995. The algorithm is inspired by the social behavior of birds flocking and fish schooling, and has been proven to be a powerful competitor to other evolutionary algorithms such as genetic algorithms in nonlinear optimization problems. PSO starts with an initial population of random particles and searches for optima by following a combination of two main components: a) self-perception and b) social cognition. In each iteration, particles move towards their best known experience (self-perception) and the entire swarm's best known experience (social cognition). The following equations explain the movements of particles in each iteration:

v_{id}(k+1)=ωv_{id}+c₁r₁(p_{best,id}−x_{id})+c₂r₂(g_{best,d}−x_{id})

x_{id}(k+1)=x_{id}(k)+v_{id}(k+1)

In these equations, w is the inertia weight, c₁ and c₂ are acceleration constants, r₁ and r₂ε[0, 1] are random variables, x_{id}ε[Xₘᵢₙ, Xₘₐₓ] and v_{id}ε[−Vₘₐₓ, Vₘₐₓ], i=1, 2, . . . , M, d=1, 2, . . . , D are position and velocity of the i-th particle, respectively, where M is the swarm sixe, D is the dimension of the optimization problem, and Xₘᵢₙ and Xₘₐₓ determine the minimum and maximum value of particle positions, and Vₘₐₓ specifies the maximum value of velocity, and p_{best,id} and g_{best,d} are the best known particle and swarm positions, respectively.

For a standard PSO method, the following steps are the basic structure (provided in pseudo-code):

```
1. Select maximum size of the swarm;
2. Generate M random particles and form a swarm “S”;
3. foreach particle in S do
      a. Randomly initialize the particle position xᵢ in
      the range of [Xₘᵢₙ,]
      b. Randomly initialize the particle initial
      velocity vi in the range of [−Vₘₐₓ, Vₘₐₓ];
      c. Set p_{best}, = xᵢ
4. endfor
5. Evaluate fitness for each particle in S;
6. Set g_{best} equals to the particle that has the best
fitness;
7. while termination condition not met do
      a. foreach particle in S do
            i. Update the particle velocity;
            ii. Update the particle position;
      b. endfor
      c. foreach particle in S do
            i. Set p_{best}, = xᵢ if xᵢ has better fitness
            compared to p_{best},;
            ii. Set g_{best} = p_{best}, if p_{best}, has better fitness
            compared to g_{best};
      d. endfor
8. endwhile
```

As can be determined from the above steps, unlike a Genetic Algorithm, PSO has no evolution operators such as crossover and mutation. In fact, the exploitation and exploration are embedded in the algorithm through self- and social cognitions and Inertia terms. The combination of cognition terms and inertia guarantees exploitation by contributing in the particles convergence to a best-known solution. The solution, however, may not necessarily be the global optima. To this end, two random coefficients in the velocity equation are considered to increase the search space, allowing for further exploration over the problem space. The inertia term also plays a role in exploration by limiting the momentum of particles. Due to presence of inertia term, particle velocities cannot easily be changed, leading to a more thoroughly exploration between current position of particle and best local and global positions.

A Genetic Algorithm (GA) may also be used for optimization purposes. A Genetic Algorithm (GA) is a stochastic and evolutionary algorithm for optimization and global search whose search method models genetic inheritance and Darwinian Evolution Theory. Genetic Algorithms are well-known in the field and a person skilled in the art would know how to adapt and implement such a method for the system of the invention.

Other concepts and algorithms or methods which may be used with the system of the invention for optimizing the candidate layouts include: crossover, scattered (uniform) crossover, single-point crossover, two-point crossover, intermediate (blending) crossover, mutation, and action-based genetic algorithm. These and other optimization strategies not discussed here may be used with the system of the invention to reduce, optimize, and adjust the various candidate layouts.

As noted above, one of the more important aspects of layout generation is the placement and positioning of corridors in the layouts. To this end, a method which provides more useful corridors than other algorithms was developed. The steps in this corridor placement method are as follows:

```
1. Set direction vector as {up, down, left, right}
2. Select a gird in the largest empty space and set as
start point
3. Initialize direction of each grid
4. Set initial cost of interior grids of rooms as
infinity
5. Set initial cost of grids belonging to outside area
to infinity
6. while all rooms not connected do
    a. Select a room that is not connected to empty
    space;
    b. Select a grid of the room and set as target
    point;
    c. Initialize the closed list as empty list;
    d. Set open list as start point;
    e. Set cost of start point as zeros;
    f. while the open list is not empty do
        i. Find the node with the lowest cost on the
        open list, call it current point;
        ii. Pop current point off the open list;
        iii. Set current point as parent of all
        possible successor nodes generated by
        direction vector;
        iv. foreach successor do
            1. if the successor is the target point
                a. Place corridor of the grids on
                closed list;
                b. Go to step 3;
            2. endif
            3. Calculate the cost to get to the
            successor starting from start point,
            and call it “g”;
            4. Estimate the cost for the successor
            to reach the target point, and call it
            “h”;
            5. Set successor's cost equals g+h;
            6. if the successor has not been
            previously met
                a. Append the successor node to
                open list
                b. Continue;
            7. elseif the successor belongs to open
            list
                a. update the cost and direction
                in open list if less costly route
                is found
            8. elseif the successor belongs to
            close list
                a. update the cost and direction
                in close list if less costly route
                is found
            9. endif
        v. endforeach
        vi. Append parent node to closed list
    g. endwhile
11. endwhile
12. Construct corridor starting from start point and
following direction of grids found through the
algorithm
```

Since the above described system may result in a large number of candidate layouts, a number of methods were used to determine which layouts may be suitable for further consideration and which layouts can be discounted. Some of these methods include penalizing layouts which have unsuitable characteristics. One example of such a method is the use of boundary terms. A boundary term is used to limit a room's coordinates to be within the input space's borders. In a given layout, if a room cannot be placed partially or completely within the space's borders, the layout will be penalized to direct the room to the nearest grid within which the room can be completely placed in. Another method is the use of corridor length. A layout is penalized if the corridor length in that layout exceeds the minimum required corridor area. The numerical value of the penalty grows proportionally depending on how much the required corridor area is exceeded.

A layout may also be penalized based on the area occupied by a specific room or desired area. A layout will be penalized if any room has a smaller area than required. The numeric value of the penalty will increase exponentially as the difference between the value of the area for a specific and the desired numerical value for the area for that room increases.

Another method which may be used to generate suitable layouts is the use of a room repelling field when generating layouts. During the operation of a genetic algorithm, it is possible to obtain layouts with overlap between rooms. To avoid overlapping and to directing rooms to empty spaces, a repelling field centered at each room can be used. In a situation where two rooms overlap, the layout will be penalized proportional to how much area is covered by the overlap. The numerical value of the penalty varies by the strength of the room fields at the overlapping points.

As an extension to the room repelling field concept, a layout density field may be used. Rooms repelling fields are necessary to avoid overlapping, however they do not provide information about the location of other rooms that may result in back and forth movement of rooms. Therefore, an additional term is required to direct the movements of rooms. To this end, a layout density field may be used. To form the field, each room generates a field with enough width to cover the whole layout. The layout density field will then be formed by taking the summation of each individual field. A layout can be ranked based on the density field distribution. A higher rank will be given to a layout with a more uniform distribution of rooms.

An empty spaces attraction field may also be used to better determine a layout's suitability. An empty spaces attraction field is similar to the layout density field, with the main difference being in the application of the two. Layout density fields allow for a more uniform distribution of rooms, while empty space attraction field is used to move selected rooms when a layout does not meet one or multiple requirements.

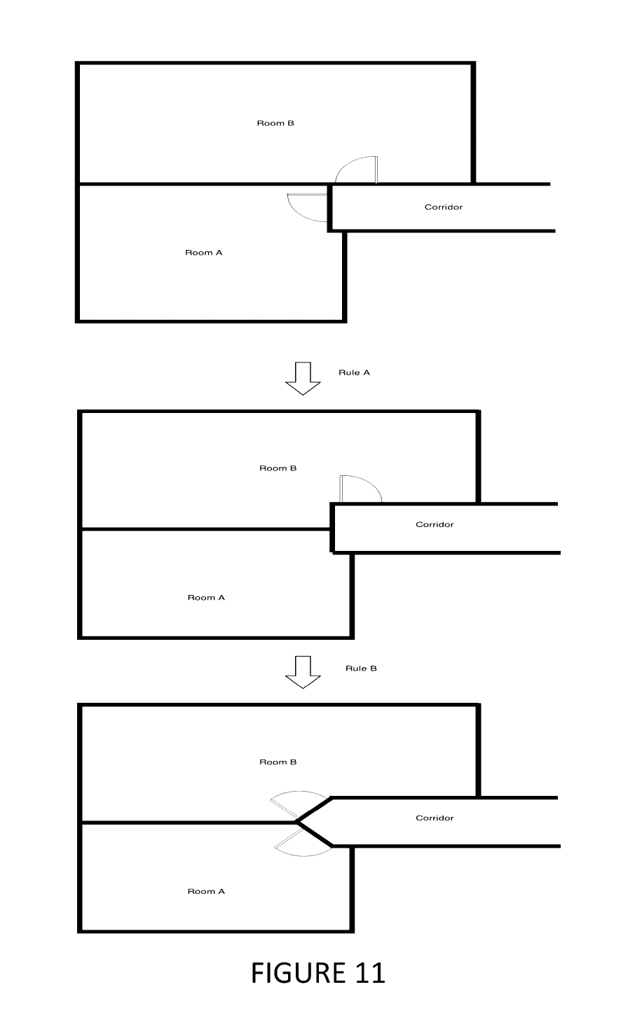

As a final step prior to providing the user with the candidate layouts which conform to the requirements for the space, any adjustment or fine tuning step may be performed on the various candidate layouts. For such an adjustment step, the positions and surface areas of the various rooms in the layout are not significantly changed. Minor changes which improve the layout and which may improve the realism (or implementation) of the layout are applied. This fine tuning may be illustrated with reference to FIG. 11.

In FIG. 11, the corridor is moved up by applying a Rule A. Then, the T intersection is replaced by a Y junction (by applying Rule B) and the door removed in the first step is replaced. Thus, with minimal changes to the floor areas and locations of the various rooms, a more aesthetically pleasing layout is obtained. A user can select which rules are to be applied to the candidate layouts. As well, a user can select parameters for these rules including the order in which they may be applied and the limits to their application (e.g. minimums and maximums by which rooms and locations may be adjusted).

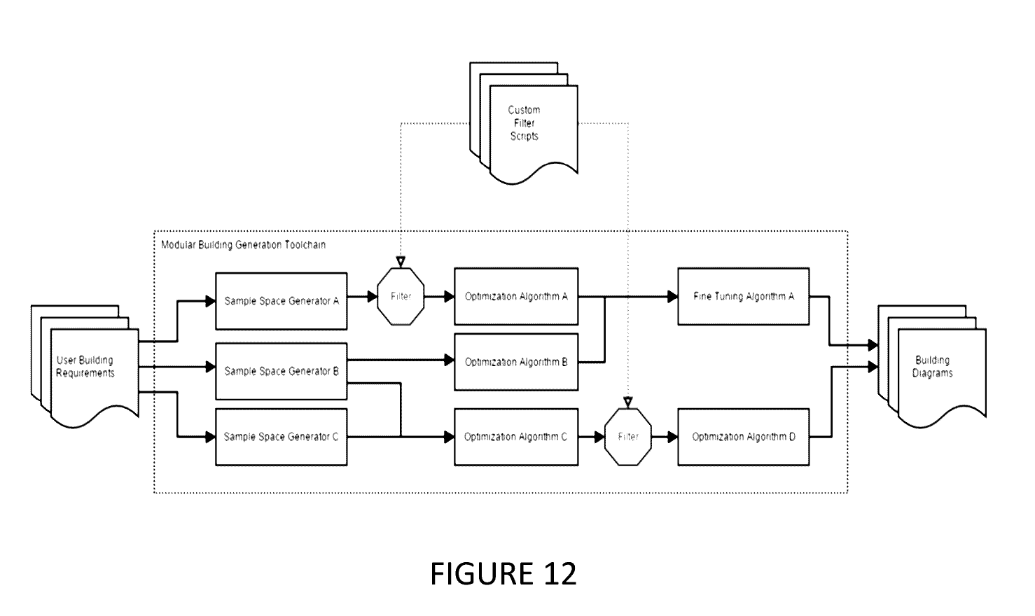

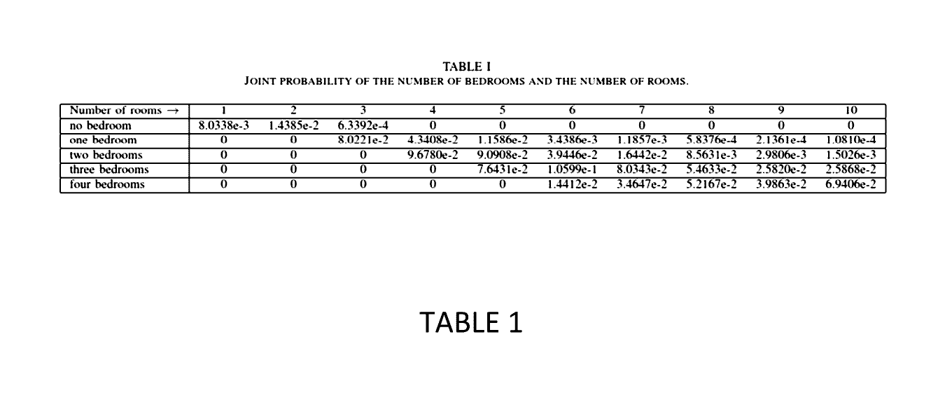

Referring to FIG. 12, a block diagram of a sample implementation of one aspect of the invention is illustrated. In this implementation, the user's building or space requirements are entered and are then simultaneously received by separate space or layout generators, each of which may be implemented by a different software module. Each generator may use a different algorithm or method for generating layouts. The various layouts generated by the separate generators can then be optimized by different optimization algorithms, each of which may be implemented by a separate software module. As can be seen, however, the various generated layouts may be filtered using a filter script. The filter script can test for a layout's suitability based on the user requirements or using any criteria deemed necessary for a suitable layout. Sample filter methods are outlined above. It should be noted that the filtering may be done before or after a layout is optimized (as shown in the diagram). Once optimization is done, the layouts can then be adjusted for fine tuning prior to being presented to the user as building diagrams.

It should also be clear that the optimization process may take more than one step. As can be seen at the bottom of FIG. 12, layouts may be optimized, then filtered, then optimized again. Conversely, layouts may be generated, then filtered, then optimized prior to being adjusted for fine tuning.

Once candidate layouts have been suitably filtered, optimized, and adjusted for fine tuning, these layouts are then presented to the user as building diagrams. It should be noted that a processing network as shown in FIG. 12 may be defined by an expert user to better customize the outputs for various styles of types of buildings.

It should also be noted that the different modules illustrated in FIG. 12, as well as others, may have their connections reconfigured by a user to generate different types of layouts. In one aspect of the invention, the infrastructure illustrated in FIG. 12 as modules may be provided to a user and the user can configure the processing paths between the modules so that the layout requirements and the automatically generated layouts that conform to those requirements are processed according to the user's specifications. Each module may have one or more processing/generation algorithms coded within such that a user can pick and choose which algorithms are to be used for his or her own ends. As well, one or more modules may also be user configurable such that a user may code in the processing algorithm to be resident in a module. Thus, not only are layouts customized to the user's specifications but the processing used to generate those layouts can also be customized by the user.

While the above description notes the use of the various aspects of the present invention for generating layouts for spaces, the present invention may be used for other ends. As an example, the system of the invention may be used to generate layouts for the placement of furniture for a redecoration of a space. Similarly, the system of the invention may be used to determine the potential placement of windows, doors, light fixtures, and other fixed parts of a room. As well, the present invention may be used to maximize or minimize the dimensions of a room or a corridor in a given space. By judiciously applying a suitable constraint or requirement and entering the characteristics of a given space, the area/length of a room or corridor can be maximized or minimized as desired.

In addition to the above uses, the present invention may also be used to generate layouts and plans for virtual spaces. As such, the system and methods of the present invention may be used to generate layouts of areas to be used as locales and maps for games or for other uses which may need virtual layouts. This includes the generation of layouts for use in video games, board games, virtual reality simulations, or any other endeavour that may require a virtual layout whether based on the non-virtual world or not.

The system of the invention may be implemented as a standalone application on a dedicated computer. Alternatively, it may be implemented as a web enabled application accessible to users via a browser-based environment. Similarly, the system may be implemented as a library of software modules accessible to users by way of specific function calls. A user may thus incorporate the various functions and capabilities of the system by merely incorporating the library in his or her application.

In one implementation, the dedicated computer used to operate the system used an Intel i7 CPU with 32 GB of RAM. In other implementations, the system resides on a server and is accessible to users by way of the Internet or by any suitable computer network. In such implementations, the system is operated on a software as a service basis. Authenticated users would access the system and upload/enter space requirements/characteristics and the system would produce multiple space layouts and configurations which conform to the user entered requirements.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g. “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for generating at least one design layout for a space, the method comprising:
a) receiving parameters for said space;
b) determining a number and type of desired areas for said space;
c) determining dimensions of said desired areas;
d) placing said desired areas in said space based on predetermined constraints;
e) determining connecting corridors for said space to connect at least one desired area with another desired area;
f) adjusting dimensions of said desired areas to account for said connecting corridors; and
g) placing said connecting corridors in said space.

2. A method according to claim 1, wherein said number and type of desired areas are based on said parameters.

3. A method according to claim 1, wherein said number and type of desired areas are based on previously gathered data regarding similar spaces.

4. A method according to claim 1, wherein dimensions of said desired areas are determined based on previously gathered data for similar spaces.

5. A method according to claim 1, wherein step b) comprises receiving input from a user for said number and type of desired areas.

6. A method according to claim 1, wherein said predetermined constraints are based on a hierarchical tree indicating which desired spaces are to be placed within other desired spaces.

7. A method according to claim 1, wherein said desired areas comprise rooms in a residence.

8. A method according to claim 1, wherein said desired areas comprise offices in said space.

9. A method according to claim 1, wherein corridors are placed based on a graph detailing which desired spaces are to be connected to other desired spaces.

10. A method according to claim 1, wherein walls of desired spaces are shifted to allow for corridors.

11. A method according to claim 1, wherein multiple layouts are generated for a single space.

12. A method according to claim 11, wherein said multiple layouts are filtered to remove layouts which do not conform to user requirements.

13. A method according to claim 12, wherein said multiple layouts are filtered by applying a cost function to each one of said multiple layouts and removing layouts which have high costs according to said cost function.

14. A method according to claim 11, further comprising a step of optimizing at least one of said multiple layouts to increase a number of user requirements conformed to.

15. A method according to claim 14, wherein said step of optimizing is accomplished by applying at least one optimization method to said at least one of said multiple layouts, said at least one optimization method being at least one of:
simulated annealing;
particle swarm optimization; and
genetic algorithm.

16. A method according to claim 11, wherein at least one characteristic of a layout is optimized.

17. A method according to claim 11, further comprising a step of searching said multiple layouts for layouts which conform to user requirements.

18. A method according to claim 17, wherein said step of searching accomplished by applying at least one method for determining a layout's suitability, said at least one method comprising at least one of:
use of scoring to determine a layout's suitability;
use of a penalty function with said scoring such that layouts with unsuitable characteristics are penalized;
use of a room repelling field;
use of a layout density field;
use of an empty spaces attraction field.

19. A method according to claim 11, wherein said multiple layouts are generated using at least one of:
a shuffled squarified treemap method;
a squarified treemap method;
a minimal rectilinear partitioning method;
an evolutionary squarified treemap method.

20. Non-transitory computer readable media having encoded thereon computer readable and computer executable code which, when executed, implements a method for generating at least one design layout for a space, the method comprising:
a) receiving parameters for said space;
b) determining a number and type of desired areas for said space;
c) determining dimensions of said desired areas;
d) placing said desired areas in said space based on predetermined constraints;
e) determining connecting corridors for said space to connect at least one desired area with another desired area;
f) adjusting dimensions of said desired areas to account for said connecting corridors; and
g) placing said connecting corridors in said space.
